(19) United States
(12) Patent Application Publication
(10) Pub. No.: US 2011/0247652 A1
(43) Pub. Date: Oct. 13, 2011

(54) DEVICE AND METHOD FOR CONTROLLING AN ELECTRIC MOTOR

(75) Inventor: Joachim Zimmer, Changsha (CN)

(73) Assignee: ROBERT BOSCH GMBH, Stuttgart (DE)

(21) Appl. No.: 13/063,056

(22) PCT Filed: Jul. 31, 2009
(86) PCT No.: PCT/EP2009/059977

§ 371 Date: Jun. 29, 2011

(30) Foreign Application Priority Data
Sep. 9, 2008 (DE) 10 2008 041 893.5

(51) Int. Cl. B08B 1/00; A47L 1/02; H02P 29/00

(52) U.S. Cl. 134/6; 318/473; 15/250.12

(57) ABSTRACT

The invention relates to a method and a device for controlling an electric motor (2), wherein an operating voltage and an operating current is supplied to an electric motor (2), and at least one measurement variable (4, 6, 7, 8) characterizing the electric motor temperature is recorded, wherein the torque discharged by the electric motor during operation is maintained nearly constant regardless of the temperature of the electric motor (2).

### BACKGROUND OF THE INVENTION

The invention relates to a method and to a device for controlling an electric motor, in which method an operating voltage and an operating current are supplied to an electric motor and the torque output during operation is limited to a predefinable maximum value by regulating the operating voltage or the operating current.

Methods of the type cited in the introductory part are used, for example, to protect mechanical components, which are driven by the electric motor, from damage caused by overloading. In this case, the mechanical components can comprise, for example, a windshield wiping device of a motor vehicle or a comfort function, for example a window winder or sunroof.

DE 100 31 925 A1 discloses determining the maximum torque of an electric motor after production of same and storing it in a parameter of the motor control system. As a result, manufacturing tolerances can be compensated for by electric motors with a particularly high maximum torque being limited to a predefinable maximum value.

DE 101 44 985 A1 discloses setting the torque, which is output by an electric motor, during operation and taking into account the transmission ratio. As a result, damage to downstream components by great forces which occur when a low transmission ratio and a high torque of the electric motor meet can be avoided.

However, all the known prior art methods share the common feature that the maximum torque which occurs is determined at a fixed ambient temperature. These methods do not take into account the change in the maximum torque as the ambient temperature of the electric motor changes. However, particularly in the case of permanent-magnet electric motors, the maximum torque rises as the temperature drops. As a result, downstream components can be mechanically overloaded when the known limiting methods are used at low temperatures, this mechanical overloading causing said components to, for example, rupture or undergo plastic deformation.

### SUMMARY OF THE INVENTION

The object of the invention is therefore to avoid overloading of mechanical components when they are driven by an electric motor.

According to the invention, this object is achieved by a method for controlling an electric motor, in which method an operating voltage and an operating current are supplied to an electric motor and at least one measurement variable which characterizes the temperature of the electric motor is recorded, with the maximum torque output by the electric motor during operation being kept virtually constant, irrespective of the temperature of the electric motor.

The object is also achieved by a device for controlling an electric motor, which device is designed to supply an operating voltage and an operating current to an electric motor, with the device containing an arrangement for detecting at least one measurement variable which characterizes the temperature of the electric motor, and also containing a limiting arrangement by way of which the maximum torque output by the electric motor during operation can be kept virtually constant, irrespective of the temperature of the electric motor.

The invention solves the problem of the maximum torque of a permanent-magnet electric motor increasing as the temperature decreases. According to the invention, the operating voltage and/or the operating current are controlled such that a predefinable maximum torque is not exceeded. In this respect, the invention proposes, rather than measuring the starting torque of the electric motor directly, determining the temperature of the electric motor and/or the temperature of the area in which the electric motor is installed and limiting the electrical power consumed by the electric motor as a function of the measured or calculated temperature so that the increase in torque as the temperature decreases is compensated for.

However, it goes without saying that a person skilled in the art is, in this case, familiar with the possibility of there also being a small increase in torque or else a decrease in torque as the temperature drops, on account of the measurement accuracy of the temperature, on account of non-linearities in the increase in torque and on account of control deviations of the electric motor. However, any increase in torque which may possibly remain is always lower than in the case of an electric motor according to the prior art. The invention does not teach generating an absolutely straight torque profile as a solution principle.

The output signal from a temperature sensor which is arranged within the housing of the electric motor can be used, for example, as a measurement variable which characterizes the temperature of the electric motor. In a further embodiment of the invention, provision may be made to read out the resistance of the windings and to determine the temperature of the electric motor from the temperature dependence on this resistance. Provision may also be made to record the operating current and the operating voltage of the electric motor and to model the temperature of the electric motor from the consumed electrical power, the efficiency and the ambient temperature by means of an energy balance. Finally, provision may be made to model the temperature of the electric motor from an ambient temperature. The ambient temperature can be determined, for example, from the external temperature, the temperature of the engine compartment, the oil temperature of the internal combustion engine or the coolant temperature of said internal combustion engine in a motor vehicle.

In order to increase the reliability, provision may be made, in a development of the invention, to temporarily switch off the torque-reduction means of the electric motor under predefinable operating conditions. This prevents the output torque of the electric motor being reduced in the event of disturbed determination of the measurement variable which characterizes the temperature and, at the same time, a high torque requirement. An operating state of this kind may be present, for example, in a motor vehicle above a predefinable speed.

Provision may also be made to reduce the output motor torque by a fixed predefinable value in the event of disturbances in the recording of the measurement variable which characterizes the temperature. This value can be, for example, approximately 5% to approximately 20%, in particular approximately 10%.

### BRIEF DESCRIPTION OF THE DRAWINGS

The invention will be explained in greater detail below with reference to exemplary embodiments and figures, without restricting the general concept of the invention.

FIG. 1 shows the torque profile of an electric motor plotted against the rotation speed for various temperatures according to the prior art.

FIG. 2 shows the torque profile of an electric motor plotted against the rotation speed for various temperatures according to the invention.

FIG. 3 shows a block diagram of an electric motor with associated actuation electronics.

FIG. 4 shows a further block diagram of an electric motor with associated actuation electronics and the incorporation of said electric motor in an on-board electrical system.

FIG. 5 shows a block diagram of an electric motor, the actuation electronics of said electric motor and the incorporation of said electric motor in an on-board electrical system of a vehicle according to a further exemplary embodiment.

### DETAILED DESCRIPTION

In the text which follows, the invention will be explained with reference to a windshield wiping device of a vehicle as an exemplary embodiment. However, in this case, it goes without saying that a person skilled in the art is familiar with the possibility of the disclosed principles also being applied in any other field of engineering in which a mechanical device is driven by means of a permanent-magnet electric motor.

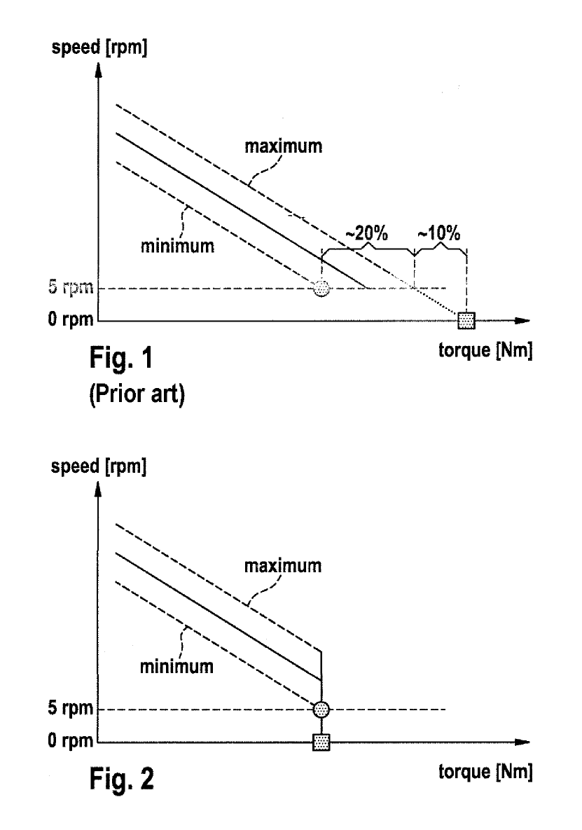

FIG. 1 shows the torque of an electric motor on the abscissa and the associated rotation speed of the motor on the ordinate. The solid line shows the typical profile for a permanent-magnet electric motor from the minimum specified rotation speed, 5 revolutions per minute (rpm) in the example, to the maximum rotation speed. In the exemplary embodiment according to FIG. 1, the torque decreases linearly as the rotation speed increases.

In addition, the torque output by the motor is still dependent on the temperature of the motor. The solid curve profile according to FIG. 1 applies to a nominal temperature of +20° C.; an increase in the temperature, for example to +40° C. or +50° C., leads to a decrease in the torque, as illustrated by the curve illustrated by the dashed line and labeled “minimum”. When the temperature reduces, for example to −30° C. to −40° C., the curve profile designated “maximum” is produced.

The increase in torque as the rotation speed decreases also continues below the minimum rotation speed, in the example in FIG. 1, 5 rpm. Therefore, the maximum torque is reached at a rotation speed of 0 rpm, that is to say when the motor is stationary, and the lowest possible use temperature. This operating point is marked by a square in FIG. 1.

At the same time, an electric motor for driving a mechanical component has to be of such a size that the lowest maximum torque is sufficient to drive the component. This is established at the minimum specified rotation speed and the highest use temperature. This operating point is marked by a circle in FIG. 1.

FIG. 1 shows that the maximum torque varies by approximately 30% at the minimum rotation speed and the highest temperature (circle) and when the motor is blocked and at the lowest temperature (square). For a specific intended use, the electric motor therefore has to be selected such that the driven mechanical component is reliably driven at the operating point marked by a circle. At the same time, the mechanical component has to be of such a size that it is not destroyed at the operating point marked by a square. Therefore, the mechanical component is oversized for most operating states and is therefore disproportionately heavy and expensive.

In the case of a windshield wiping device, the operating point with the minimum rotation speed and the minimum torque corresponds, for example, to operation at a high temperature and a high speed, which causes a high wind loading. The maximum torque occurs, for example, when the wiper motor is cooled down in cold weather after the vehicle has been stationary for a relatively long period of time and the windshield wiping device is blocked due to freezing or snow loading.

FIG. 2 shows an identical graph to FIG. 1, but with the electric motor being actuated by way of the method proposed according to the invention.

The motor does not experience any throttling at a maximum specified use temperature and a rotation speed above the specified minimum rotation speed. The output torque follows, with the rotation speed, the profile of the curve identified by “minimum”. The electric motor reaches its maximum torque (circle) at the maximum use temperature and the minimum rotation speed (5 rpm). If the rotation speed now drops below the specified minimum rotation speed, the resulting increase in torque is compensated for by a reduction in the electrical power supply, and therefore the torque does not increase further (square). Provided that the electric motor is operated at a lower temperature, the torque profile follows, for example, the solid line in FIG. 2 or, at the lowest possible use temperature, the curve identified by “maximum”. In this case, the limit for the consumed electrical power is not established in the first instance at the minimum specified rotation speed but at an earlier time in order to prevent the torque increasing above the maximum value at a high operation temperature. This limiting of the maximum torque prevents overloading of the wiper rod. Therefore, this can be designed more easily and cost- effectively.

It goes without saying that the curve profile according to FIG. 2 is to be considered only to be an example. In further embodiments of the invention, provision may be made, for example, to accept an increase in torque, as the temperature drops, as far as the minimum rotation speed and to limit the torque only when the rotation speed drops below the minimum rotation speed.

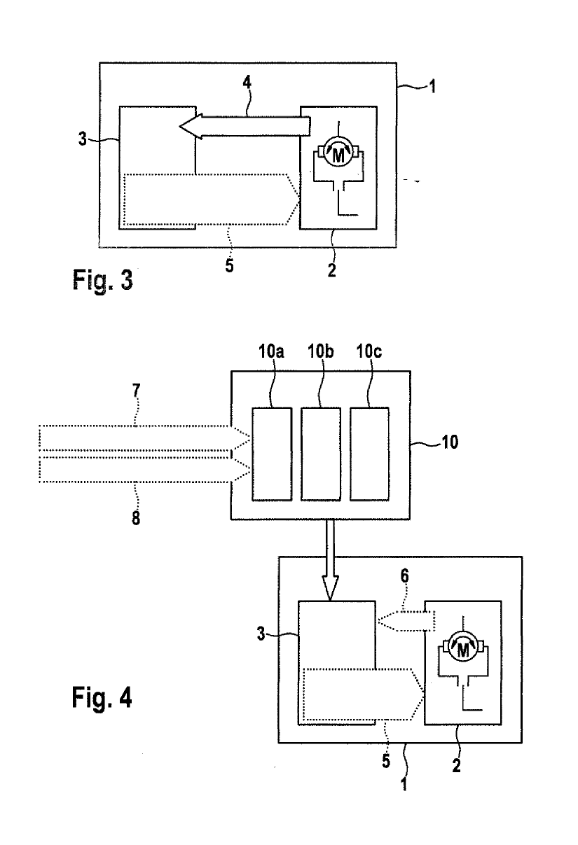

FIG. 3 shows a block diagram of an electric motor 1. The electric motor 1 comprises the known parts 2 of a permanent-magnet electric motor comprising a rotor, a stator, a commutator and connection lugs. These parts are familiar to a person skilled in the art and therefore not illustrated in detail in FIG. 3.

The electric motor 1 also comprises control electronics 3. The control electronics 3 are designed to provide an operating current and an operating voltage 5 to the electromechanical parts 2. In this way, the torque output by the electromechanical parts 2 can be controlled by regulating the electrical power supplied to the electromechanical parts 2.

The control electronics receive an input signal 4 which is generated by a temperature sensor which determines the temperature of the motor 2. In this case, the temperature sensor 4 can be arranged within the motor housing 2 and thus directly measure the temperature in the region of the motor windings.

The control electronics 3 limit the electrical power 5, and therefore the torque output by the electromechanical parts 2, as a function of the measurement values from the temperature sensor 4.

The control electronics 3 are preferably integrated in a housing 1 together with the electromechanical parts 2. In this case, the user is provided with a compact electric motor 1, the maximum torque of this electric motor remaining virtually constant irrespective of the temperature.

FIG. 4 shows an electric motor 1 and the integration of said electric motor in an on-board electrical system 10 which is, for example, a constituent part of a motor vehicle. The electric motor 1 has, as explained in connection with FIG. 3, parts 2 of a permanent-magnet electric motor which is combined with the control electronics 3 to form a housing.

The control electronics 3 influence the supply current and/or the supply voltage and therefore control the electrical power 5 which is supplied to the electromechanical parts 2.

In the exemplary embodiment according to FIG. 2, the temperature is determined from an energy balance instead of by a temperature sensor 4. To this end, the control electronics 3 supply a measurement signal of the recorded electrical power of the motor 2 via the path 6. With the aid of the efficiency which can be stored, for example, in a storage device of the control electronics 3, the thermal loading on the electromechanical parts 2 is determined by the control electronics 3. This thermal loading is the input variable to a thermal energy balance from which the temperature of the parts 2 which is established can be calculated.

The electric motor 1 is incorporated in an on-board electrical system 10 of a vehicle. The on-board electrical system 10 is subdivided into a plurality of electrical subsystems 10A, 10B, 10C, . . . which administer different tasks. For example, the motor 1 can be supplied with electrical energy from the on-board electrical system 10.

Furthermore, the vehicle has two temperature sensors 7 and 8. In this case, the temperature sensors 7 and 8 are connected to the electrical subsystem 10A of the on-board electrical system 10. The temperature sensor 7 is provided, for example, for the purpose of determining the external temperature in the area surrounding the vehicle. Furthermore, a temperature sensor 8 which determines the coolant temperature of the internal combustion engine of the motor vehicle is provided. The ambient temperature at the site of the electric motor 1 can be calculated from the two temperatures in order to thus be able to determine the thermal energy loss from the motor 1 and, from this, the temperature of the parts 2.

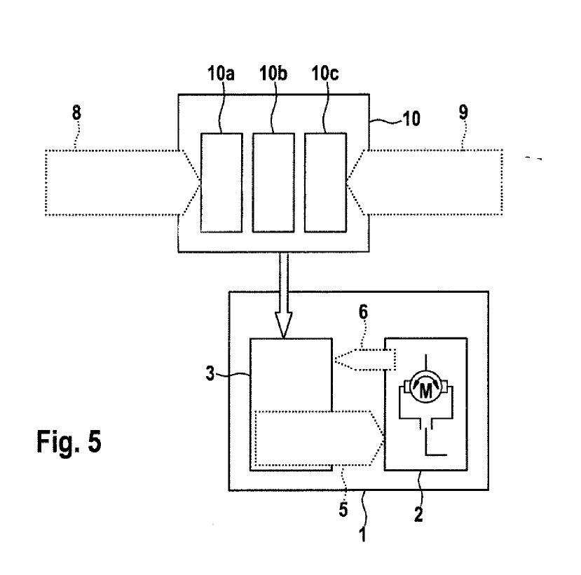

FIG. 5 shows the same design of a motor 1 with control electronics 3. The motor 1 is integrated in an on-board electrical system 10, as has been explained in connection with FIG. 4, in the exemplary embodiment according to FIG. 5 too. A temperature sensor 8 transmits information relating to the ambient temperature to the control electronics 3 via the electrical subsystem 10A of the on-board electrical system 10. Said control electronics can therefore determine the temperature of the motor 2 from the measurement value 6 of the recorded electrical power in an energy balance, as already explained above.

Speed information 9 which is supplied to the control electronics 3 via the electrical subsystem 10C of the on-board electrical system 10 is also provided in the exemplary embodiment according to FIG. 5.

The speed information 9 can be used by the control electronics 3 for the purpose of temporarily stopping the torque-limiting means of the electric motor 2 by limiting the supplied electrical power 5 when the vehicle is moving at a speed above a predefinable limit value. The limit value can be, for example, approximately 100 km/h, approximately 120 km/h or approximately 140 km/h. The limit value is selected by a person skilled in the art such that the situation of the windshield wiping device being blocked by snow loading or by freezing solid usually no longer occurs at such a traveling speed. At the same time, the required torque is increased on account of the wind loading. An undesired reduction in torque on account of a malfunction would therefore have a negative effect on the wiping speed and thus on the roadworthiness.

If the threshold value is undershot, the torque-limiting means of the electric motor 2 is switched on again by the control electronics 3. In order to avoid frequent switching operations, a further limit value, which is different from the first limit value, can be provided for this purpose.

It goes without saying that a person skilled in the art is familiar with the invention not being restricted to the illustrated exemplary embodiments. Rather, modifications and changes can be made when implementing the invention, without substantially changing the invention per se. Therefore, the above description should be considered to be explanatory rather than restrictive.

1. A method for controlling an electric motor (2), the method comprising:
supplying an operating voltage and an operating current to an electric motor (2); and
recording at least one measurement variable (4, 6, 7, 8) which characterizes the temperature of the electric motor; and
maintaining the maximum torque output by the electric motor (2) virtually constant during operation, irrespective of the temperature of the electric motor (2).

2. The method as claimed in claim 1, further comprising selecting the measurement variable (4, 6, 7, 8) which characterizes the temperature of the electric motor from at least one of an external temperature (7), a cooling-water temperature (8), and a power consumption (6) of the electric motor.

3. The method as claimed in claim 1, further comprising reducing the maximum torque output by approximately 5% to approximately 20% if it was not possible to record the measurement variable (4, 6, 7, 8) which characterizes the temperature of the electric motor.

4. The method as claimed in claim 1, wherein the maximum torque output by the electric motor (2) during operation is not limited in predefinable operating situations.

5. The method as claimed in claim 1, wherein the electric motor (2) is configured to drive a windshield wiping device.

6. A device (3) for controlling an electric motor, the device designed to supply an operating voltage and an operating current to an electric motor (2), the device (3) comprising:
an arrangement for detecting at least one measurement variable (4, 6, 7, 8) which characterizes the temperature of the electric motor; and
a limiting arrangement (5) by way of which the maximum torque output by the electric motor (2) during operation can be kept virtually constant, irrespective of the temperature of the electric motor (2).

7. The device as claimed in claim 6, wherein the arrangement for detecting at least one measurement variable (4, 6, 7, 8) which characterizes the temperature of the electric motor comprises at least one temperature sensor (4, 7, 8).

8. The device as claimed in claim 6 wherein the limiting arrangement (5) can be switched off under predefinable operating conditions.

9. The device as claimed in claim 6, wherein the device (3) controls an electric motor (2) of a windshield wiping device.

10. A computer program, having a program code which is stored in a non-transitory machine-readable storage medium, when the computer program is run on a computer, the computer carrying out a method comprising:
supplying an operating voltage and an operating current to an electric motor (2); and
recording at least one measurement variable (4, 6, 7, 8) which characterizes the temperature of the electric motor; and
maintaining the maximum torque output by the electric motor (2) virtually constant during operation, irrespective of the temperature of the electric motor (2).

11. The computer program as claimed in claim 10, further comprising program code for selecting the measurement variable (4, 6, 7, 8) which characterizes the temperature of the electric motor from at least one of an external temperature (7), a cooling-water temperature (8), and a power consumption (6) of the electric motor.

12. The computer program as claimed in claim 10, further comprising program code for reducing the maximum torque output by approximately 5% to approximately 20% if it was not possible to record the measurement variable (4, 6, 7, 8) which characterizes the temperature of the electric motor.

13. The method as claimed in claim 1, wherein the measurement variable (4, 6, 7, 8) which characterizes the temperature of the electric motor is an external temperature (7).

14. The method as claimed in claim 1, wherein the measurement variable (4, 6, 7, 8) which characterizes the temperature of the electric motor is a cooling-water temperature (8).

15. The method as claimed in claim 1, wherein the measurement variable (4, 6, 7, 8) which characterizes the temperature of the electric motor is a power consumption (6) of the electric motor.

16. The device as claimed in claim 6, wherein the arrangement for detecting at least one measurement variable (4, 6, 7, 8) which characterizes the temperature of the electric motor comprises an arrangement for detecting the electrical power (6) consumed by the electric motor.

17. The device as claimed in claim 6, wherein the arrangement for detecting at least one measurement variable (4, 6, 7, 8) which characterizes the temperature of the electric motor comprises at least one temperature sensor (4, 7, 8) and an arrangement for detecting the electrical power (6) consumed by the electric motor.
